(19) United States
(12) Patent Application Publication
(10) Pub. No.: US 2016/0157010 A1
(43) Pub. Date: Jun. 2, 2016

(54) VARIABLE DEVICE FOR DIRECTING SOUND WAVEFRONTS

(71) Applicants: Helmut OELLERS, Erfurt (DE); ADVANCED ACOUSTIC SF GMBH, Potsdam (DE)

(72) Inventors: Helmut Oellers, Erfurt (DE); Frank Stefan Schmidt, Potsdam (DE)

(73) Assignees: Advanced Acoustic SF GmbH, Potsdam (DE); Helmut Oellers, Erfurt (DE)

(21) Appl. No.: 14/904,637

(22) PCT Filed: Sep. 11, 2014
(86) PCT No.: PCT/IB2014/001805

§ 371 Date: Jan. 12, 2016

(30) Foreign Application Priority Data
Jul. 12, 2013 (DE) 102013011696.1

(51) Int. Cl. H04R 1/40; H04R 1/02; H04R 1/36

(52) U.S. Cl. CPC H04R 1/403; H04R 1/36; H04R 1/026; H04R 2201/025; H04R 2201/405

(57) ABSTRACT

A variable device for directing sound wavefronts. In one example, individual housings including sound transducers can be shifted relative to one another in such a way that a wavefront adapted to the respective reproduction requirements can be produced. This configuration can be re-designed by mechanically shifting the individual elements of the variable device again.

The present invention relates to a variable device having a plurality of sound transducers for directing sound wavefronts and to a method for directing the sound transducers.

### BACKGROUND

Point sources of sound radiate uniformly in all directions. But it is often essential to direct the radiation emitted by sound transducers in a particular direction. This requires a spatial extent of the emitting system of at least half the length of the radiated wavefront. A common solution to the task of directing the radiation is to mount a plurality of sound transducers in a row, as a so-called line array. When mounted vertically, in the azimuth plane these have the same emission characteristic as the individual sound transducer, but in the elevation plane a marked directivity is formed.

This arises because it is only in the axis of the line array that all signals from the individual sound transducers arrive at a point at almost the same time. It is only at this point that their sound pressure values sum together in the entire frequency range. Outside this axis cancellation of the signals occurs, firstly at short wavelengths, i.e. in the upper frequency range, because at certain angles they arrive with approximately the same amplitude but opposite phase. In addition to these zero points, so-called side lobes are formed, conditioned by the finite number of elementary waves of which the wavefront is composed.

The mechanical arrangement of such a group of coherently driven sound transducers also enables their emission characteristic to be adapted to the prevailing requirements. One example of this is given by line arrays, or individual loudspeakers usually mounted on top of one another in a “banana” formation, which due to their directivity radiate more sound energy in the most distant seating areas than in the areas just in front of the stage. In the azimuth plane the line arrays also have the broad emission characteristic of the individual loudspeakers.

It is also possible electronically to influence the response characteristic of such line arrays in the elevation plane. The individual sound transducers are then no longer driven coherently, but the signals for each individual sound transducer are electronically delayed relative to one another. They then no longer arrive simultaneously along the main axis, but rather along a new axis, defined by the delay times of the individual emitters relative to one another. The mechanical curvature of the system is thus emulated by the electronic delay of the individual signals.

It is often necessary, however, to direct the sound in more than one plane. If sound is to be supplied only to a specific area or to a specific point in the room, then the radiation from a group of emitters must be directed in two axes.

An electronically controllable means to do this is a two-dimensionally structured arrangement of transducers which is organised according to the principle of wave field synthesis [1]. However, the cost of this is extremely high, which means that it is usually not economically feasible.

Another solution involves the use of curved reflectors [2]. A point sound source at the focal point of a parabolic mirror can thus generate a parallel wavefront which carries the sound over large distances at almost the same level. Such reflectors can also be curved such that the sound is focussed at a point of focus (hereafter also designated as focus point and focal point) [3].

An interesting approach to limiting the sound very selectively onto a narrow range is described in [4]. The 192 sound transducers in the “Sonic Chandelier” focus the sound extremely sharply in one direction.

Wavefronts which are directed in this manner have significant advantages over the relatively lightly directed radiation from individual sound transducers. They excite unwanted reflections of the listening space to a lesser degree. Their acoustic behaviour is therefore less significant for the sound reproduction. It is precisely under challenging acoustic conditions where this becomes a crucial advantage. Speech intelligibility is significantly increased because the direct sound component is greater. The sound field can be restricted to a dedicated region, in order to reduce the disruptive effect on adjacent areas.

The surface of a directed wavefront grows more slowly with the distance from the sound source than is the case with the spherical radiation pattern from a point sound source. Given a sufficient number of sound transducers, a parallel wavefront can also be formed, the level of which does not, in theory, decrease with distance apart from diffraction losses and sound attenuation due to air. In the case of concave wavefronts, the level of the signal at the focal point is even much higher than at the sound transducers themselves.

Unfortunately the arrangement of sound transducers described in [4] cannot be varied. It cannot be adapted to changing requirements on the radiation characteristic. The requirements on the directivity of the wavefront, however, vary greatly with the application.

### BRIEF DESCRIPTION OF THE DRAWINGS

FIG. 1 shows an example variable device for directing sound wavefronts

FIG. 2 shows an example of a variable device including a group of housings.

FIG. 3 shows another example of a variable device for directing sound wavefronts.

FIG. 4 shows another example of a variable device including sound transducers connected to form groups, for directing sound wavefronts.

FIG. 5 shows another example of a variable device including sound transducers connected to form groups, for directing sound wavefronts.

FIG. 6 shows another example of a variable device for directing sound wavefronts.

FIG. 7 shows another example of a variable device for directing sound wavefronts.

FIG. 8 shows an example of an application of a variable device for directing sound wavefronts.

### DETAILED DESCRIPTION

An object of the present invention, therefore, is to design a variable device composed of sound transducers that can be adapted to suit the requirements of the shape of the wavefront to be generated. The intention here is to avoid the high cost associated with a purely electronic means of directing a wavefront.

A directed wavefront, which arises from the superposition of the elementary waves, is intended to be directed towards the audience region by the mechanical design of a variable device composed of sound transducers. The individual elements of the device are to be combinable and reusable to form a device of scalable overall size. The elementary acoustic waves of the individual elements should be able to be assembled together such that they generate convex or concave wavefronts.

With the convex wavefronts thus generated, a selected coverage region in front of the arrangement of sound transducers can be supplied with considerably more acoustic energy than the areas outside this region to be covered. In the case of a concave surface of the arrangement, the acoustic power of the arrangement of sound transducers is able to be focussed at one or more points.

The above objects and other objects which emerge from the description are achieved by a device according to the features of Claim 1 and by a method according to the features of Claim 9. Further advantageous embodiments of the invention are given in the dependent claims.

According to the invention, a variable device for directing sound wavefronts is provided, which is characterized in that the device consists of more than two individual housings with sound transducers, which can be shifted relative to one another by means of a positive connection between the individual housings in such a manner that the acoustic centres of the individual sound transducers can be directed in two spatial axes with respect to the shape of the wavefront to be generated such that, by shifting the housings relative to one another, both concave and convex sound wavefronts can be produced even when all sound transducers are supplied with the same audio signal from a common source. In this way, the radiation from the arrangement of sound transducers can be directed onto the desired area.

In this arrangement, it is not necessary to direct the individual sound transducers towards the listener. As long as the diameter of the sound transducers remains small in relation to the wavelength of the radiated audio signal, each individual sound transducer radiates relatively uniformly in all directions. It is only the superposition of the wavefronts that gives the common wavefront its direction of propagation. For this reason, it is possible to displace the individual housings of the sound transducers parallel to one another.

The elementary waves generated by the sound transducers of the arrangement can be combined by the variable device into a closed wavefront according to Huygen's principle. By means of a variable mechanical arrangement of the individual sound transducers relative to one another, where the transducers are coupled with an electronic time delay between individual signals, a form and directivity can be provided which is matched to the respective application.

The two-dimensional spatial arrangement of the variable device for directing sound wavefronts offers an advantage. The matching of the sound transducers to the load impedance of the air is improved significantly. Because of its low viscosity, air can easily bypass the movements of an individual diaphragm, and at low signal frequencies the sound transducer operates almost into empty space. This mismatching leads to the very low efficiency that single sound transducers with small diaphragm diameters tend to have in the bass and fundamental range. The sound transducers of the variable device, arranged close together, do not allow air to bypass the diaphragm for the superposition of acoustic elementary waves, because adjacent sound transducers generate the same sound pressure level at the same moment. The efficiency increases and the natural resonance of the sound transducer drops due to the mass of the upstream air column. Accordingly, the frequency response of the variable device is to be equalised as a function of its overall size in order to allow superposition of acoustic elementary waves.

This equalization, with the improved efficiency of the sound transducers in the bass range and their natural resonance shifted towards the lower frequencies, enables sufficient sound pressure to be generated deep into the fundamental range even with sound transducers of small diameter and relatively high free-field resonance. The diaphragm deflections of the individual sound transducers remain small, because the resulting overall diaphragm becomes very large.

On the other hand, sound transducers of small diameter are capable of responding quickly to signal changes over the entire frequency range. This means that the clearly audible dips in the frequency response curve due to reflections from the diaphragm mounting and the flexural waves on the diaphragm itself, which are unavoidable in large diameter loudspeakers, are barely present. The variable device for directing sound wavefronts can therefore, depending on its overall size, generate the full audio spectrum, from the deep fundamental range up to the upper frequency limit of the individual small sound transducers, from a single origin at the centre of the radius of curvature. This avoids the phase problems which necessarily occur when the audio spectrum is divided up across multiple spatially separated sound transducers. The distance between two points in space can only be equal to a single point in the horizontal plane. For all other listeners the individual components of the signal arrive at different times. In addition, the short response time of the variable device for directing sound wavefronts ensures a very good impulse response over the entire frequency range, one of the most important prerequisites of high quality audio reproduction.

Another substantial advantage of the variable device for directing sound wavefronts is that the curvature of its surface can be determined by the position of the virtual origin of the sound wavefront. The further the centre of curvature is placed behind the radiator surface, the narrower is the emission angle. The direct wave, which appears to originate from the virtual sound source, is in principle only audible in the region in which it can be seen from the listener's position. This fact can be exploited to limit the radiation of the wavefront to a desired area.

This allows the shape of the wavefront to be adjusted to match the desired coverage region. In principle, apart from the diffraction and aliasing effects which arise because of its finite size, the virtual sound source which arises at the centre or origin of the radius of curvature of the variable device for directing sound wavefronts is only audible at places where, from the listener's point of view, it is located in the region of the variable device for directing sound wavefronts.

A large distance between the centre of the radius of curvature and the variable device for directing sound wavefronts provides a clear advantage over conventional sound transducers. The surface of the device is then only slightly curved.

The surface area of the wavefront which it radiates then also increases with distance at a correspondingly slow rate. For a correspondingly large overall arrangement, the sound pressure level directly in front of the variable device for directing sound wavefronts is then barely higher than at a distance of many meters away. For this reason, the kinds of problems which occur due to the dangerously high sound pressure in the vicinity of the sound transducers of conventional public address systems can be reduced significantly.

In addition, in a large, more weakly curved variable device for directing sound wavefronts of sound transducers, the feedback threshold increases much further compared to conventional public address systems, when an artist performs with his or her microphone in the area in front of the sound transducers. Here the sound pressure level directly in front of the sound transducers is not much higher than in the audience area, while in the case of point sound sources it increases very steeply according to a 1/r function immediately in front of the sound transducers. The difference between these two, distance-dependent, values is also the difference in the overall loop gain, which determines the point at which the acoustic feedback cuts in.

An additional advantage of such a virtual sound source being arranged far behind the variable device for directing sound wavefronts is that the apparently so distant origins of the wavefronts barely change their direction when the listener changes his or her position in the reproduction space. This enlarges the sweet spot of a stereo or surround-sound reproduction, if the device for directing sound wavefronts is designed to be broad enough that the listener remains in the coverage area.

The individual sound transducers can be aligned in relation to one another in different ways. Thus, in appropriate 3D CAD programs, an arrangement can be defined in which the acoustic centres of the individual sound transducers have the same distance to a virtual sound source or to the desired focal point. This can then be used to produce templates with which the individual housings are aligned in rows and columns before being locked together.

A further option for directing (aligning) the sound transducers is provided by a geometric calculation of their position in a coordinate system. According to the calculated table, the distances from the front panel of each individual housing to a plane in front of the variable device for directing sound wavefronts, or to a reference point in the co-ordinate system, can then be measured and adjusted.

For focal points, an additional option consist in placing a microphone at the focal point and supplying a reference loudspeaker at the centre of the variable device for directing sound wavefronts with a recurring short pulse. The same signal is then routed one at a time to each of the sound transducers to be aligned, and the respective sound transducer is shifted until the pulse edges in the oscilloscope trace match.

If the resulting surface form of the variable device for directing sound wavefronts is to be re-used at other locations in the same configuration, then it is not necessary to distribute the whole device over each individual housing. The displacement can be marked on the interfaces of portable units. The positive connection is then released only at these points and the resulting block is transported to the next site ready assembled.

A significant advantage of the mechanical alignment of the sound transducers over the electronic solutions for controlling the directivity of loudspeaker groups is that not every sound transducer requires its own amplifier and complicated signal processing to drive it. Using suitable combinations of series and parallel connections, the individual sound transducers can be connected together in such a way that they can be connected to a common commercially available final stage amplifier.

This does not exclude the possibility of the individual housings being fitted with a small, dedicated output stage. The wiring of the device for directing sound wavefronts would then be simpler to configure, especially as the supply voltage for the output stages could be provided from a common mains power supply.

Several preferred embodiments in accordance with the present invention are illustrated in the following detailed description, but are not intended as limiting the present invention thereto.

The shifting of the individual housings containing the sound transducers relative to one another can be used to construct the desired form of a wavefront. With a convex shape, it can produce a directed radiation onto the desired area, or if assembled in a concave shape, it can form a focus point at which the total acoustic energy of the variable device for directing sound wavefronts accumulates.

A positive connection between the individual housings can be advantageously formed if these are implemented from profile material with an appropriate configuration of the external walls. Any type of positive connection is possible, however.

There are also many possible ways of locking together the individual housings after the aligment has taken place. For example, one practical method would be to provide an eccentric locking mechanism on the rear wall of the housings, which presses against the side wall of the adjacent individual housing and thus prevents any further displacement of the housings relative to one another.

In doing so, it may become necessary to sharply curve the front of the variable device for directing sound wavefronts. If the individual housings of the variable device are not deep enough to guarantee a positive connection of the individual housings, then it may be necessary to insert stabilizing elements between them. These can be, for example, short frames made from the same housing profile from which the individual housings are manufactured.

In a preferred application of the variable device for superimposing acoustic elementary waves, two different curvatures of the radiator surfaces can be interlaced with each other. Accordingly, the individual sound transducers in their housings are alternately assigned to the different planes and supplied with the respective signal associated with the respective curvature.

If the planes of interlaced variable devices for directing sound wavefronts diverge widely from each other, then they can be held together using connecting elements of appropriate length. In each case however, it is necessary to ensure that the overall surface of each plane remains closed. Any sound transmission between the front and rear in the area of the variable device for directing sound wavefronts would negate the advantage of the better matching of the sound radiators to the load impedance of air in the overall surface.

Another way of closing the gaps which arise in such a case is to control groups of sound transducers inside the variable device for directing sound wavefronts in a staggered manner. The part of the variable device for directing sound wavefronts in which the mechanical displacement of the individual housings relative to one another does not jeopardise the mechanical stability of the device as a whole, is then mechanically displaced. At those points where the curvature of the wavefront is small, and it is difficult to maintain a closed mechanical structure, it is also possible to combine the mechanical displacement of the individual radiators with an electronic offset.

If the partial surfaces are sufficiently large, then the focussing of the signals even allows different signals to be sent to both ears of the listener at a given point. The virtual headphones obtained as a result enable a good spatial reproduction of individual content, for example even in places where, due to the associated hygiene problems, the wearing of conventional headphones is not possible but reproduction of the signal outside of the desired spot is distracting.

If the focal points of the partial surfaces are spatially separated from one another, then different listeners can also be positioned at the focal points. Different content can then also be assigned to them. For example, in front of the screen on which a presentation is shown at fairs and exhibitions, points could be marked at which different languages can be heard. Here also, the sound pressure level falls off rapidly outside the focal points.

If, for example, a curved shape of the variable device for directing sound wavefronts is required to generate a focused sound source at its focal point, then the inner area can easily be implemented from sound transducers which are only slightly shifted relative to one another. If the overall surface area of the device is large and the focal point is not far away from it, then the displacements of the individual sound transducers relative to one another in the outer region of the arrangement become very large. This will also result in a large overall depth of the arrangement that may not be able to be mechanically accommodated at the installation site.

In this case, a combination of the mechanical curvature of the surface with a partial electronic delay of groups of sound transducers can offer a solution. The outer sound transducers are then connected together in vertical columns and supplied with the audio signal first. The columns which lie further in receive their signal delayed long enough for it to arrive simultaneously with the signal of the outer column, which has a longer acoustic path to the listener. Finally, the inner region of the variable device for directing sound wavefronts, which is curved in two axes, is supplied with the audio signal.

Such a combination of mechanical and electronic delays of whole groups of elementary waves has a wide range of other possible applications. It can also be used if the variable device for directing sound wavefronts is arranged as a frame around a flat surface for displaying images. As long as the surface for displaying the image is not sound absorbent and is sealed against the variable device for directing sound wavefronts, then, due to the half-space radiation, the radiators benefit from at least a +6 dB increase in level in the bass and fundamental range.

As is the case with other focused sound sources, it can also be necessary in this application to direct the wavefronts not onto a single point, but onto an extended area with a restricted vertical range. This is very easily achieved if a larger radius is selected for the curvature of the variable device for directing sound wavefronts in the vertical plane than for the curvature in the horizontal plane.

In this case, for example, rather than two focal points, there are two regions with a definable vertical extent which are produced in front of the image display, in which audiences of various sizes also experience the stereo impression of the virtual headphones. The fall-off of the sound level to the side of this region then remains unchanged, however the signal behind the listener will propagate further than is the case with the narrow focal points.

Such a frame around an image display, which in terms of its orientation can be adjusted to suit the conditions in the reproduction space, also offers a solution in the home cinema market for increasing the direct sound component of the central channel at the listener's seat. This increases the direct sound component at the listener's seat. The speech intelligibility is therefore better and the effect of distracting reflections from an acoustically poorly designed reproduction space is less important.

If the variable devices for directing sound wavefronts are wide enough, the residential market can also become an interesting area of application of the invention. This is due to the high direct sound component, coupled with the good impulse response of the device and the extended sweet spot as a result of the distantly placed virtual sound sources of a moderately curved arrangement.

The high direct sound component in a narrow focussing range allows for many applications of the variable device for directing sound wavefronts. In office workplaces it is often very distracting if the sound unintentionally propagates throughout the whole room. A large number of such individual signals often results in a high diffuse-field sound level, which spreads to every point in the room. The only remedy then is to wear headphones when working. Partition screens, such as are also erected between workstations in call centres, could solve the problem if they were combined with a variable device for directing sound wavefronts. At the focal points it would not only be possible to hear the signals without interference from other employees.

Another possible area of application for the variable device for directing sound wavefronts is for instance in theatres. It is precisely in large halls where the problem often occurs that the performers on the stage are not loud enough without the aid of electro-acoustic equipment. While this problem can certainly be solved with appropriate amplification, a new problem arises. The first wavefront of the sound radiators is then usually louder in the audience area than the performers themselves. It follows that the voice is then perceived above the stage or from the direction of the right or left loudspeaker, which significantly detracts from the artistic impression of the performance.

From the view of the artists this is a very serious problem, a solution to which is being investigated at present by expensive technical means. But what has been lacking up to now is a proposal for a way in which the sound transducers can be accommodated unobtrusively in the elevation plane of the performers.

In many cases a solution to this problem is provided by means of the variable device for directing sound wavefronts. They could also be arranged such that they radiate alternately forwards and backwards or left and right. Such a surface radiating to the left and right could easily be placed behind an item of stage scenery without being visible to the audience. The directed wavefronts of the lateral radiation from the side could then be reflected from appropriately arranged stage elements into the audience area. Using a pan-pot, the engineer adjusts the origin of the resulting phantom sound source which arises in the audience area, to track the position of the relevant performer on stage. Since the direction of the sound waves from the performer and electronic support equipment is now almost identical, but the first wavefront at every seating position originates from the performer him or herself, the audience associates all of the sound to the performer him or herself, and will barely even notice the electronic support.

The shape of the variable device for directing sound wavefronts can be adjusted to suit the geometric conditions of the theatre venue in such a way that the wavefronts from the reflections from flat pieces of scenery are distributed largely uniformly in the hall. On the other hand, it may be also be possible for the variable device for directing sound wavefronts to generate a plane wave, which by appropriate shaping of the reflective surface is distributed evenly over the audience area. A combination of the two options is also possible.

A preferred embodiment in accordance with the present invention is described in the following drawings and in a detailed description, but is not intended as limiting the present invention thereto.

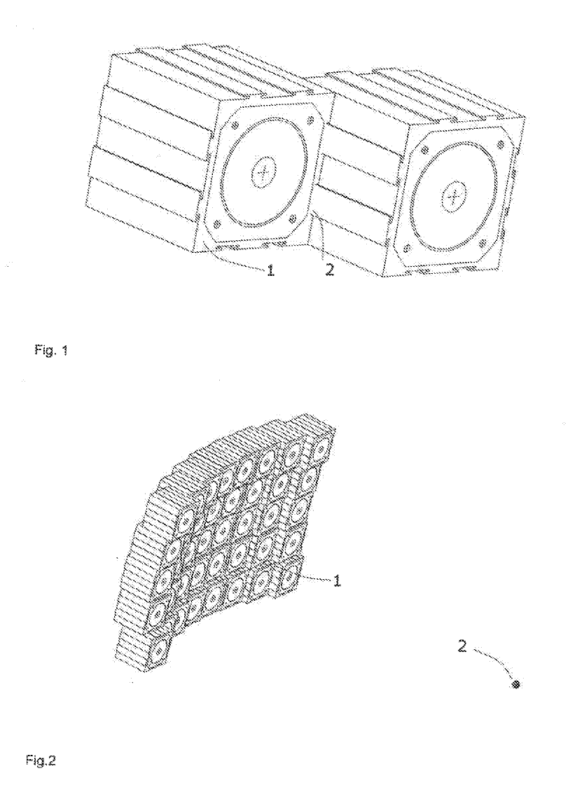

FIG. 1 shows an exemplary solution as to how the sound transducers could be installed in a variable device for directing wavefronts. The closed housing (1) can be constructed from continuously cast profile (continuous casting profile), for example. If a bass reflex port is provided, then it may only end in the front face, not in the rear face.

The sound transducer that generates the respective wavefront is mounted on the front face. The profiles of the housings can be designed such that they can be shifted relative to one another in a positive connection (2).

FIG. 2 shows a group of such closed housings (1) which have been directed so that their centres are at an equal distance from a focal point (2). The wavefronts of their elementary waves therefore arrive there with the same phase in the entire audible frequency range. It is only at this point therefore that the individual amplitudes sum together in the entire the frequency range of the audio signal.

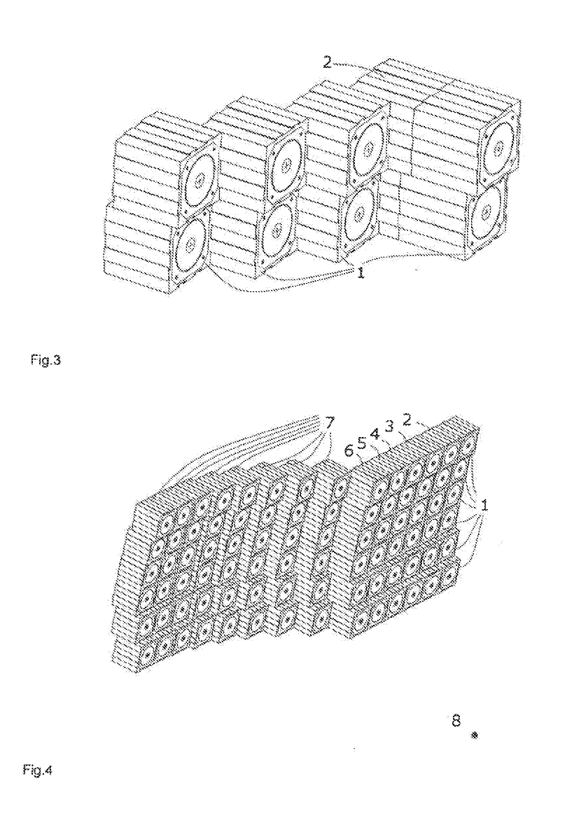

FIG. 3 shows a possible solution to a problem which can occur when the wavefront to be generated has a small radius of curvature. Then, the displacements of the individual speaker housings (1) relative to one another, particularly at the outer region of the variable device for directing sound wavefronts, are so large that a direct positive connection is no longer possible. This can be overcome by an empty frame (2) which is screwed onto the rear of the loudspeaker housing and made of the same profile material as the loudspeaker housing. It is open to its end faces, so that the cable connections can be routed through it to the sound transducer.

FIG. 4 shows a combination of the mechanical and an electronic solution. The inner region (7) of the device for directing sound wavefronts is mechanically matched to the shape of the wavefront to be generated. In the outer region the individual sound transducers in the example sketched would have to be moved a large distance from one another in order to realise the radius of curvature to the focal point of the inner region. In addition to the mechanical problems this would also result in the device for directing sound wavefronts having a very large installation depth. This is overcome by a time delayed control of individual loudspeaker groups. The curvature of the arrangement is then only continued in one axis. In the other axis the individual sound transducers are connected together to form groups. In the example, all sound transducers (1) are controlled with a common signal. The columns (2) to (6) will receive their signal time-delayed. The inner group (7) is delayed the most. The individual delays are chosen such that all signals arrive at the focal point (8) at the same time.

FIG. 5 shows an interlaced arrangement of two radii of curvature in a device for directing sound wavefronts. All sound transducers (3) shown with a dot in FIG. 5 focus their wavefront at the focal point (1). The sound transducers (4) shown without this dot are directed to the adjacent focal point (2) to the right. The two groups of transducers are controlled with separate signals. For example, different languages might be audible at the focal points.

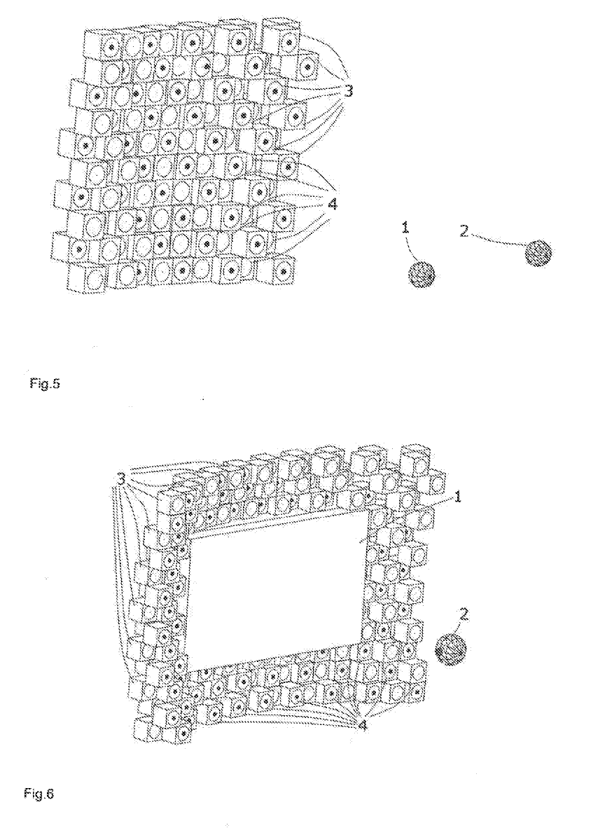

FIG. 6 shows such an interlaced arrangement around a display screen (1). The sound transducers are again divided into groups (3) and (4), where each group is supplied jointly with its signal. The radii of curvature of the groups are designed such that their focal points are located near the ears of a listener (2). The group (3) then generates the left signal and the group (4) the right signal of a stereo reproduction, which can only be heard clearly at the specified location.

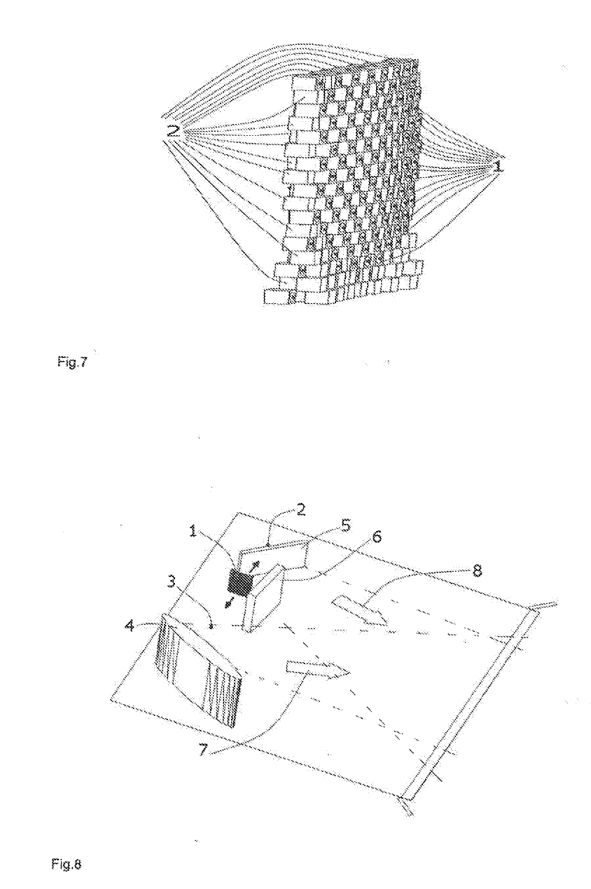

FIG. 7 shows a convex curved device for directing sound wavefronts which radiates to two sides. The sound transducer groups (1) and (2) are again interlaced with one another, but with opposite orientation. Each group is controlled by a common signal.

FIG. 8 shows an example of a possible application of such a bidirectionally radiating, convex curved device for directing sound wavefronts (1) on a theatre stage. The curvatures of the resulting radiator surfaces are curved around the virtual sound sources (2) and (3). Because of their relatively large distance from the device for directing sound wavefronts, a small opening angle of the radiation is obtained. The surface of the radiated wavefront therefore grows only slowly with distance, and therefore the sound pressure level also only falls gradually with the distance from the sound transducers. The sound is deflected by the reflective scenery items (4) and (5) into the audience area, and the device for directing sound wavefronts is visually hidden by a scenery item (6). The artists may also move freely with their microphones in the radiation regions (7) and (8), because due to the long acoustic path to the virtual sound sources and the small drop in level towards the audience area, the feedback threshold is very high.

The present invention of a variable device for directing sound wavefronts enables the sound transducers to be easily mounted on a curved surface and locked in place, which allows the shape of the wavefront to be variable. Individual housings with sound transducers can be shifted relative to one another in such a way that a wavefront is produced which matches the respective requirements for the sound reproduction. This shape can be reconfigured by mechanical displacement of the individual elements of the variable device.

According to Huygen's principle, curved wavefronts can be generated from elementary waves. Suitable temporal or spatial displacement of the elementary waves allow curved wavefronts to be created that either appear to originate from a virtual sound source or cumulate at a focal point. Often it is sufficient to generate one or two virtual sound sources or focal points, so that the mechanical direction of the individual sound transducers is easier to implement than equivalent electronic solutions.

If the sound transducers are mounted on a curved surface, a virtual sound source is produced at the centre of the radius of curvature. If it is located behind the device, this means that a wavefront can be directed towards the audience area very efficiently. A concave wavefront with a focal point is produced when the centre of the curvature is placed in front of the arrangement of sound transducers.

According to one exemplary embodiment, a variable device for directing sound wavefronts consists of more than two individual housings with sound transducers, which can be shifted relative to one another by means of a positive connection between the individual housings in such a manner that the acoustic centres of the individual sound transducers can be directed in two spatial axes with respect to the shape of the wavefront to be generated such that, by shifting the housings relative to one another, both concave and convex sound wavefronts can be produced even when all sound transducers are supplied with the same audio signal from a common source.

According to an extension, the curvature of its surface can be defined by the position of the virtual origin of the sound wavefront, which is located at the centre of the radius of curvature and from which the direction and opening angle of the radiated wavefront can be determined if said origin is positioned behind the device, and at which the elementary waves of the individual sound transducers sum together in phase, so that a focused sound source is produced when it is positioned in front of the device.

As a rule, the diameter of the individual sound transducers is selected such that it remains small in the fundamental range of the audio signal relative to the wavelength of the radiated audio signal. It is therefore not necessary to direct the individual sound transducers towards the listener.

According to a further extension the individual sound transducers are connected together as passive components by suitable combinations of series and parallel connections, in such a way that they can be connected to a common commercially available final stage amplifier or such that the individual housings are fitted with a small, dedicated output stage, wherein the supply voltage for the final stages can be provided by a single mains power supply.

According to a further extension, the radii of curvature of the device are different in the azimuth and elevation planes, in order to adjust the shape of a convex wavefront to suit the region to be supplied, or to supply a preferred region with a high sound energy level instead of the focal point of a concave arrangement.

According to a still further extension, a positive connection is implemented between the individual housings made of profile material with appropriate design of the external walls, which can also be used to extend the individual housings to the rear if the individual housings of the variable device are otherwise not deep enough to ensure a positive connection of the individual housings. This positive connection also facilitates the locking of the individual housings after the alignment is completed, by means of a mechanical lock that can be implemented in the form of an eccentric locking mechanism of the housings on their rear wall.

According to a still further extension, two different curvatures of the radiator surface are interlaced with each other, by the housings being assigned alternately to different planes which either in the same emission direction or in opposite emission directions form two different coverage areas or two spatially separated focal points, which can be supplied with different signal content.

According to a still further extension, the displacement of the individual housings relative to one another is marked at the interfaces of transportable blocks and the positive connection is released only at these interfaces to allow transporting of the device to a different installation site with the same requirements for the direction of the sound wavefronts, in order for the resulting blocks to be transported to the next site ready assembled.

The mechanical offset of the individual sound transducers relative to one another is typically defined in appropriate 3D CAD programs, in which the acoustic centres of the individual sound transducers have the same distance to a virtual sound source or to the desired focal point. From this graphical solution templates can be created, with which the individual housings are aligned in rows and columns before being locked together. The sound transducers can also be positioned in a coordinate system based on the result of a geometric calculation, or the focal points can be generated by positioning a microphone at the respective focal point and using a recurring short pulse, comparing the transit time of the sound from each sound transducer with the transit time to a reference sound transducer at the centre of the system, and aligning them.

According to a still further exemplary embodiment, a device for directing sound wavefronts has more than two individual housings, with one sound transducer being arranged in each, wherein the individual housings can be shifted relative to one another by means of a positive (and typically releasable) connection between the individual housings, in such a way that the acoustic centres of the sound transducers can be directed in two spatial axes with respect to the shape of the wavefront to be generated such that, depending on the displacement of the housings relative to one another, both concave and convex sound wavefronts can be generated by the device if all transducers are supplied with the same audio signal from a common source.

The features of the different embodiments described herein can also be combined with each other.

### BIBLIOGRAPHY

[1] Berkhout, A. J.: AHolographic Approach to Acoustic Control, J. Audio Eng. Soc., vol. 36, December 1988, pp. 977-995

[2] http://nexo-sa.com/en/systems/geosl2/technology/

[3] http://www.soundtube.com/cgi-bin/main.cgi?Speakers=start&series=6

[4] Prof. Angelo Farina, University of Parma http://pcfarina.eng.unipr.it/CdS/CdS.htm

What is claimed is:

1. A variable device for directing sound wavefronts, comprising:
more than two individual housings each of which comprises a sound transducer, wherein the individual housings can be shifted relative to one another by means of a positive connection between the individual housings, in such a way that the acoustic centres of the sound transducers can be directed in two spatial axes with respect to the shape of the sound wavefront to be generated such that, depending on the displacement of the housings relative to one another, both concave and convex sound wavefronts can be generated by the device if all transducers are supplied with the same audio signal from a common source.

2. The variable device for directing sound wavefronts according to claim 1, wherein
the acoustic centres of the sound transducers can be arranged on a surface with a radius of curvature, wherein the surface can be defined by the position of a virtual origin of the sound wavefront which is located at the centre of the radius of curvature, and from which the direction and opening angle of the radiated sound wavefront can be determined if the virtual origin is positioned behind the device, and at which the elementary waves of the individual sound transducers sum together in phase, so that a focused sound source is produced when it is positioned in front of the device.

3. The variable device for directing sound wavefronts according to claim 1, wherein
the diameter of the individual sound transducers is smaller than a wavelength of a fundamental tone of the audio signal.

4. The variable device for directing sound wavefronts according to claim 1, wherein
the individual sound transducers are connected together as passive components by suitable combinations of series and parallel connections in such a way that they can be connected to a common commercially available final stage amplifier, or such that the individual housings are fitted with a small, dedicated output stage, wherein the supply voltage for the final stages can be provided by a single mains power supply.

5. The variable device for directing sound wavefronts according to claim 1, wherein
a positive locking connection made of profile material is implemented between the individual housings with appropriate structuring of the external walls that can also be used to extend the individual housings to the rear, in order to guarantee a positive connection of the individual housings, and/or wherein the variable device additionally has mechanical locks, so that after the alignment has been carried out the individual housings can be locked by a respective mechanical lock, and/or wherein the mechanical locks are implemented in each case as an eccentric locking mechanism of the housings on their rear wall.

6. The variable device for directing sound wavefronts according to claim 1, wherein
the acoustic centres of the sound transducers can be arranged on two interlocking radiator surfaces with different curvatures, the housings being assigned alternately to different planes which either in the same emission direction or in opposite emission directions form two different coverage areas or two spatially separated focal points which can be supplied with different signal content.

7. The variable device for directing sound wavefronts according to claim 1, wherein
the radii of curvature of the device are different in the azimuth and elevation planes, in order to adjust the shape of a convex wavefront to match the region to be supplied, and/or to supply, instead of the focal point of a concave arrangement, a preferred region with a high sound energy level.

8. The variable device for directing sound wavefronts according to claim 1, wherein
groups of sound transducers within the variable device for directing sound wavefronts can be controlled with electronically delayed signals in a time-delayed manner, in order to compensate by means of this delay for a mechanical displacement of the individual emitters with respect to the listener.

9. A method for directing sound transducers of a variable device according to claim 1, comprising:
defining of a mechanical displacement of the individual sound transducers relative to one another with a computer program, typically a 3D CAD program, so that the acoustic centres of the individual sound transducers have the same distance to a virtual sound source, or to the desired focal point;
creating templates which correspond to the respective mechanical displacement between the individual sound transducers relative to one another;
aligning the sound transducers and the individual housings before they are locked in rows and columns using the templates;
carrying out a geometric calculation in a coordinate system and positioning of the sound transducers according to the calculation; and
setting up a microphone at a focal point, determining a transit time of a short sound pulse from each of the sound transducers to be aligned to the microphone and aligning said transit time with a corresponding transit time from each of the sound transducers to be aligned to a reference sound transducer at the centre of the device.

10. The method according to claim 9, further comprising:
marking a displacement of the individual housings relative to one another at the interfaces of transportable blocks, wherein to allow transporting of the device to a different installation site with the same requirements for the direction of the sound wavefronts, the positive connection is released only at these interfaces in order for the resulting blocks to be transported to the next site ready assembled.
